(19) United States
(12) Patent Application Publication
(10) Pub. No.: US 2018/0158099 A1
(43) Pub. Date: Jun. 7, 2018

(54) CUSTOM AUDIENCE GENERATION USING ENGAGEMENT TARGETING

(71) Applicant: Facebook, Inc., Menlo Park, CA (US)

(72) Inventors: Trevor Ford, San Francisco, CA (US); Divakar D. Balasubramanian, Saratoga, CA (US); Jason Jiawei Liao, Mountain View, CA (US); Ahmad Mamdouh Abdou, London (GB); Omar Mocheer Mohamed Helmy Guenena, Fremont, CA (US); Erkang You, Fremont, CA (US)

(21) Appl. No.: 15/367,145

(22) Filed: Dec. 1, 2016

(51) Int. Cl. G06Q 30/02

(52) U.S. Cl. CPC G06Q 30/0254; G06Q 30/0246

(57) ABSTRACT

An online system generates a custom audience based on user engagement with distributed content items. The online system monitors and stores user engagement with content items. A content provider submits to the online system a request to generate a new custom audience and selects audience parameters and user engagement types, such as users who watched a specified amount or percentage of a video, users who interacted with an online system page associated with the content provider, or users who clicked through online system content to a page associated with the content provider. Responsive to the request, the online system retrieves the corresponding user engagement data and applies the audience parameters to generate the custom audience and present it to the content provider.

### BACKGROUND

The subject matter described herein generally relates to web-based distribution of content, and more specifically to generating custom audiences for new content items based on user interactions with previous content.

An online system, such as a social networking system, allows its users to connect to and communicate with other online system users. Users may create profiles on an online system that are tied to their identities and include information about the users, such as interests and demographic information. The users may be individuals or entities such as corporations, brands, public personas, or charities. Because of the increasing popularity of online systems and the increasing amount of user-specific information maintained by online systems, an online system provides an ideal forum for content providers to increase awareness about products or services by presenting content items to online system users as stories in social networking newsfeeds or via other presentation mechanisms.

Users are typically presented with a large number of content items and interact with only a few of the content items received. Users often selectively interact with content items sent by the online system, and, as a result, the online system wastes resources by sending the content items that are not of interest to users. Therefore, a content provider may want to display content items to users of online systems who are likely interested in the content. However, content providers generally cannot effectively and on an ad hoc basis identify users that may be interested in that provider's content. This limitation of the information available to content providers makes it difficult for them to effectively identify content to the online system for presentation to various users.

### SUMMARY

To allow an advertiser to target content items more effectively to users of an online system, the online system generates one or more audience groups each including one or more users of the online system. For example, an audience group includes online system users having one or more common characteristics, such as engagement with content items on the online system. Content providers can use these audience groups to create target audiences for new content campaigns by identifying users with whom the content providers have an existing relationship.

The online system uses an action logger to monitor user engagement with sponsored and non-sponsored content items previously provided by content providers and stores the engagement data in an action log on the online system. A content provider may query the online system for various engagement types and related engagement interactions with the content to assess the effectiveness of the content item and/or to generate custom audiences for additional content items. By automatically monitoring and recording detailed engagement information in the action log, the content provider may retroactively identify users engaging with content, without specifying interactions of interest ahead of time. In some embodiments, the content item is a video and the engagement type reflects the amount of a time the online system user watches the video, such as for a specified period of time or to a specified percentage of completion. In another embodiment, the content item is a sponsored content item and the engagement type is the online system user following a link associated with the sponsored content item. The content provider may select a single engagement type or multiple engagement types and corresponding engagement interactions for each content item for which the content provider wishes to create a custom audience. In each of these examples, the online system automatically generates detailed user engagement data for individual content items of various types. Responsive to the content provider selecting the desired engagement types and engagement interactions, the online system queries the action log for the engagement data, and uses the engagement data and any additional parameters provided by the content provider to generate a custom audience and present the custom audience to the content provider. In addition to selecting an engagement type, the content provider may select a specific content item with which users may interact with, for example to designate a specific video of the content provider. User engagement interactions with selected content items are retrieved and used to generate a custom audience. In this way, in addition to designating content types, the content provider may specify particular content items for which to target particular user interactions. Because the online system automatically collects and retains these interactions with content items, the interaction data may be surfaced and used for targeting by a provider without knowing ahead of time which content items or interactions will later be used for targeting. This also permits a content provider to easily review different interactions that occur with different types of content and compare different audiences for different interaction types.

The features and advantages described in this summary and the following are not all-inclusive. Many additional features and advantages will be apparent to one of ordinary skill in the art in view of the drawings, specification, and claims herein.

### BRIEF DESCRIPTION OF THE DRAWINGS

FIG. 1 is a block diagram of a system environment in which an online system operates, according to an embodiment.

FIG. 2 is a block diagram of an online system, according to an embodiment.

FIG. 3 is an interaction diagram illustrating an example process for generating a custom audience of online system users based on user engagement with content items, according to an embodiment.

FIGS. 4A-4D are example user interfaces through which a content provider provides parameters for generating a custom audience, according to an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

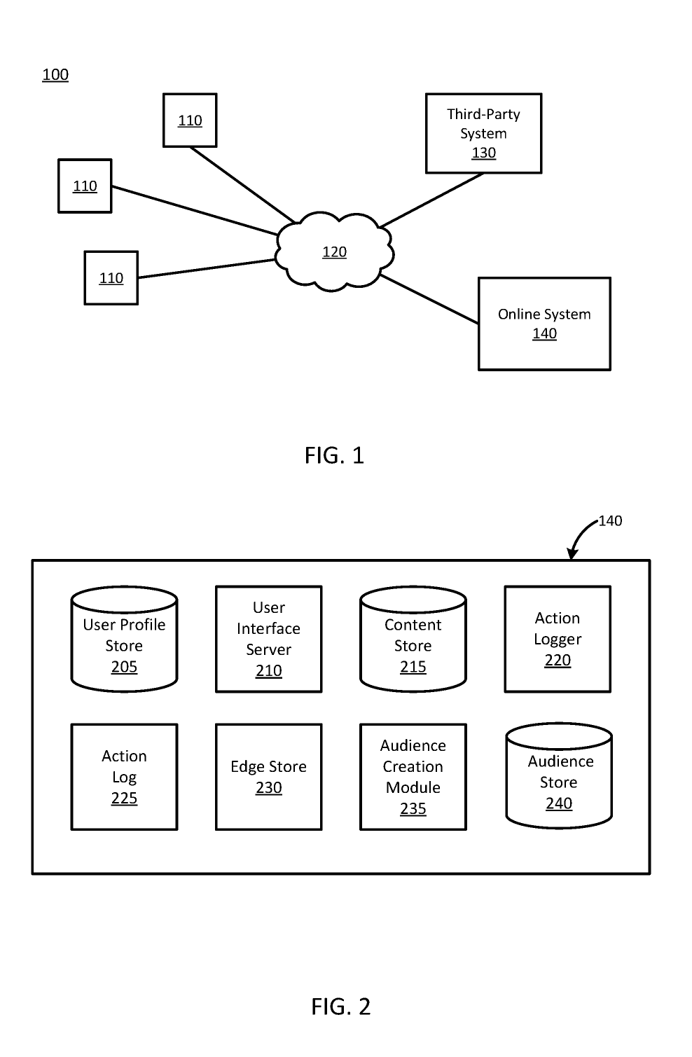

FIG. 1 is a block diagram of a system environment 100 for an online system 140. One or more users, using client devices 110, are in communication via a network 120 with a third party system 130 and an online system 140. The online system 140 may comprise a social networking system. The users can access the services provided by the online system 140 and the third party system 130 via the network 120 to view and interact with various content items. User interactions with content items may be automatically stored. When a content provider requests to target content to users of the online system 140, the user interactions with content items of the content provider are retrieved and can be used by the content provider to generate a custom audience specific to identified engagement with the content provider's content items. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system through an application programming interface (API) running on a native operating system of the client device 110, such as IOS® or ANDROID™.

The client device 110 presents content items received from the online system 140 to users of the client device 110. The client device 110 presents the content items to the user and as users interact with the content items, the client device 110 provides user interactions with the content items to the online system 140. As discussed more fully below, the user interactions may include the length of time that a user interacts with a content item, e.g., how long a user watches a video, and may also include user interactions with different portions of a content item, or how long a user views a particular content item. The client device 110 monitors certain of these interactions and provides the interaction information to the online system 140 to indicate engagement of the user with various content items when a user does or does not provide an express indication to the online system 140 of the user's interest in a content item. Thus, the interaction information may designate how long a user viewed certain information, interaction, or selection of components of a content item, or may be a request for additional content or a page of content (from the online system 140 or another system). Additional interaction information from a user is further discussed with respect to the online system 140.

The client device 110 is configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communications links of the network 120 may be encrypted using any suitable technique or techniques.

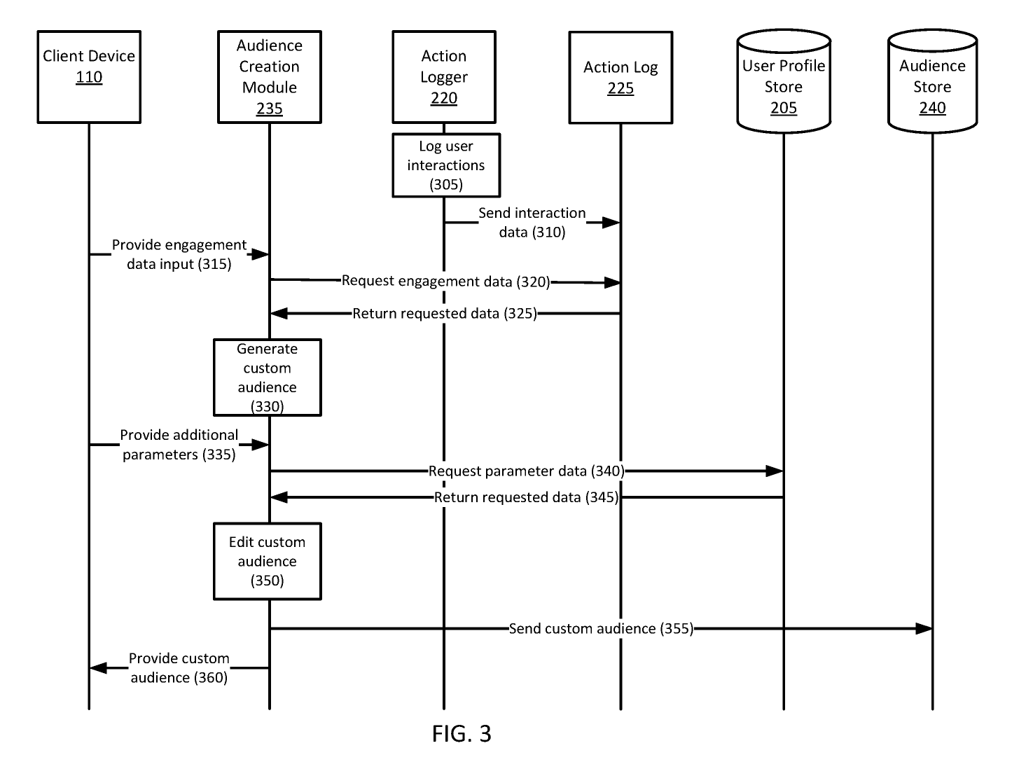

One or more third party systems 130 may be coupled to the network 120 for communicating with the online system 140, which is further described below in conjunction with FIG. 2. The third party system 130 provides content or other information for presentation via a client device 110. In some embodiments, the third party system 130 is a source of content being engaged with by a user of the client device 110. Engagement data describing user engagement interactions with content provided by the third party system 130 may be used by the online system 140 to generate a custom audience. The client device 110 monitors user engagement interactions with content items provided by the third party system 130 and sends the interaction information to the online system 140, which stores the interaction information in an action log 225.

FIG. 2 is a block diagram of an architecture of the online system 140. The online system 140 maintains information about its users and selects content items to provide to users that users can view and interact with. Among the types of content displayed on the online system 140 are content items provided by a content provider, such as sponsored content items in the form of advertisements. The online system 140 provides an interface for content providers to select an audience for their content using specific user interactions with other content items displayed on the online system 140.

The online system 140 shown in FIG. 2 includes a user profile store 205, a user interface server 210, a content store 215, an action logger 220, an action log 225, an edge store 230, an audience creation module 235, and an audience store 240. In other embodiments, the online system 140 may include additional, fewer, or different components for various applications. Conventional components such as network interfaces, security functions, load balancers, failover servers, management and network operations consoles, and the like are not shown so as not to obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location, and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The user interface server 210 links the online system 140 via the network 120 to the one or more client devices 110, as well as to the one or more third party systems 130. The user interface server 210 serves web pages, as well as other web-related content, such as JAVA®, FLASH®, XML, and so forth. The user interface server 210 may receive and route messages between the online system 140 and the client device 110, for example instant messages, queued messages (e.g., email), text messages, short message service (SMS) messages, or messages sent using any other suitable messaging technique. A user may send a request to the user interface server 210 to upload information (e.g., images or videos) that are stored in the content store 215. Additionally, the user interface server 210 may provide application programming interface (API) functionality to send data directly to native client device operating systems, such as IOS®, ANDROID®, WEBOS®, or RIM®.

The user interface server 210 generates user interfaces, such as web pages, with content from the online system 140. The user interfaces are displayed to the user through the client device 110 and the network 120. The user interface server 210 configures a user interface based on the client device 110 used to present it. For example, a user interface for a smartphone with a touchscreen may be configured differently from a user interface for a web browser on a computer.

The user interfaces provided by the user interface server 210 allow a user to generate content items and interact with content items stored in the content store 215. For example, a user interface may provide a method for a user to provide text, pictures, videos, links, and advertisements to be used to generate content items. The user interface server 210 may provide the user interface content to the third party system 130 or the client device 110. Content providers and other users of the online system 140 may use the user interface server 210 to upload sponsored or non-sponsored content items to the online system 140 for distribution to other users of the online system 140. In some embodiments, the content items are sponsored content items in the form of advertisements. The user interface server receives the uploaded content items and sends the content items to the content store 215.

The content store 215 stores objects that each represent various types of content. Examples of content represented by an object include a page post, a status update, a photograph, a video, a link, a shared content item, a gaming application achievement, a check-in event at a local business, a brand page, or any other type of content. Online system users may interact with the user interface server 210 to create objects stored by the content store 215, such as status updates, photos tagged by users to be associated with other objects in the online system 140, events, groups, or applications. In one embodiment, the objects stored by the content store 215 are sponsored content items in the form of advertisements. In some embodiments, objects are received from third-party applications or third-party applications separate from the online system 140.

In one embodiment, objects in the content store 215 represent single pieces of content, or content “items.” Hence, users of the online system 140 are encouraged to communicate with each other by posting text and content items of various types of media to the online system 140 through various communication channels. This increases the amount of interaction of users with each other and increases the frequency with which users interact within the online system 140.

The action logger 220 monitors user actions internal to and/or external to the online system 140, populating the action log 225 with information about user actions. Examples of actions including adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 225.

The action logger 220 may be used by the online system 140 to track user actions on the online system 140, as well as actions on third party systems 130 that communicate information to the online system 140. Users may interact with various objects on the online system 140, and information describing these interactions is stored in the action log 225. Examples of interactions with objects include commenting on posts, sharing links, checking-in to physical locations via a mobile device, accessing content items, and any other suitable interactions. Additional examples of interactions with objects on the online system 140 that are included in the action log 225 include commenting on a photo album, communicating with a user, establishing a connection with an object, joining an event, joining a group, creating an event, authorizing an application, using an application, and engaging in a transaction.

The user interactions captured by the action logger 220 may reflect engagement with the subject or creator of the content. As discussed below, such automatically-collected engagement information may be used after presentation of the content items to target further content to users. When users interact with content items, these interactions representing user engagement with the content items, and by proxy the content creator, are automatically recorded to be associated with a content item.

This engagement information may differ according to the type of content presented to and interacted with by the user, and generally represents express user interaction with interface elements presented to a user with the content item, and can describe other user interaction, such as length of time that a user interacted with a content item, or the amount of a content item interacted with by the user. Thus, for video content items, in some embodiments, actions logged by the action logger 220 include the amount of time that a user of the online system 140 has watched a video and/or the percentage of completion that the user reaches in the video. The action logger 220 may also store interaction information according to the type of interactions with a content item. For example, the action logger 220 in one embodiment stores a list of online system users who watched the first three seconds of a video, and in another example stores a list of users who watched any ten seconds of the video or a list of users who watched 95% of the video.

The user may also interact with additional content types, such as pages of a content provider, groups, or events of a content provider. For these content items, the engagement type may include the length of time a user views the content item (e.g., views the page), or user interaction with the content item, such as joining the group, indicating a desire to attend an event, requesting additional information for an event, and so forth.

The online system 140 may also provide a “carousel” of images or video from a content provider, which includes a series of images or videos that a user may cycle through. The rotation or selection of images in the carousel of images may represent user interactions with the carousel, for example requiring the user to pause in navigation among content items presented by the online system 140 to rotate among the series of the carousel. The interaction with the carousel, such as the number of items rotated through or the length of time a user interacts with the carousel as a whole may be captured as user interactions with the carousel content item, along with user interactions with individual content items within the carousel.

The online system 140 may also provide content items for users to enter data about themselves as a lead for a content provider. For example, the form may be provided to the content provider for the content provider to send additional information or follow up with the user about a product or service. When users select and begin entering information in such a form, many users do not complete entry of these forms. The users' partial entry of the form may be identified as interaction information with the content provider and indicate some engagement with the content provider, even when the user does not complete entry of the form.

In some examples, the content item may also provide a “canvas” or “mini-site” on the online system 140. This canvas type of content item may provide an overlay of the display of the online system and display various content within the overlay, such as an image or video of a content provider, along with additional interactive elements, such as a narrative or other description of the content provider or content items within the mini-site. The user interaction with different portions of the canvas or and content items within may be identified and stored by the action logger 220 to describe the user's engagement with the canvas.

In other embodiments, the actions include other types of user engagement with content items such as following a link associated with a content item, purchasing an item associated with a sponsored content item, expressing a preference for a content item (by, for example, “liking,” sharing, or commenting on the content item on the online system 140), or otherwise interacting with interface elements of a content item or interacting with multiple content items provided by the same content provider.

Additionally, the action logger 220 may record a user's interactions with advertisements of the online system 140 as well as with other applications operating on the online system 140. In some embodiments, data from the action log 225 is used to infer interests or preferences of a user, augmenting the interests included in the user's profile and allowing a more complete understanding of user preferences.

The action logger 220 sends the user actions to the action log 225 for storage. In some embodiments, the action log 225 stores the user actions for a specific period of time based on input from the content provider. For example, the content provider might instruct the action log 225 to store user engagement with a specific content item for 180 days. The content provider may specify different retention periods for different types of user engagement or may instruct the action log 225 to apply one retention period to all types of user engagement associated with the content provider. In other embodiments, the action log 225 stores user actions indefinitely.

The action log 225 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 225 may record information about actions users perform on a third party system 130, including webpage viewing histories, advertisements that were engaged, purchases made, and other interactions from shopping and buying.

In one embodiment, the edge store 230 stores information describing connections between users and other objects of the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Users and objects can be represented as nodes connected by these edges in a social graph. Once a user has interacted with an object, the edge in the graph links that user with that object, and this link can be used in the future to serve other content to the user related to that object to which the user has a connection.

In one embodiment, an edge may include various features each representing characteristics of interactions between users, interactions between users and objects, or interactions between objects. For example, features included in an edge describe the rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 230 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 230, in one embodiment. Alternatively, each interaction between a user and a specific object is stored as a separate edge. In some embodiments, connections between users may be stored in the user profile store 205, or the user profile store 205 may access the edge store 230 to determine connections between users.

A content provider that has previously provided content items on the online system 140 may wish to create a custom audience for a new content campaign by targeting users who have interacted with content items associated with the content provider. Targeting users that have previously engaged with the content provider's content on the online system 140 and/or the third party system 130 allows the content provider to more effectively use its resources to identify users that may be interested in its content. Responsive to receiving such a request from a content provider, the online system 140 uses engagement data collected by the action logger 220 and stored in the action log 225 to generate the custom audience ad hoc without requiring the content provider to designate specific content items or interaction information in advance of providing the content item to users.

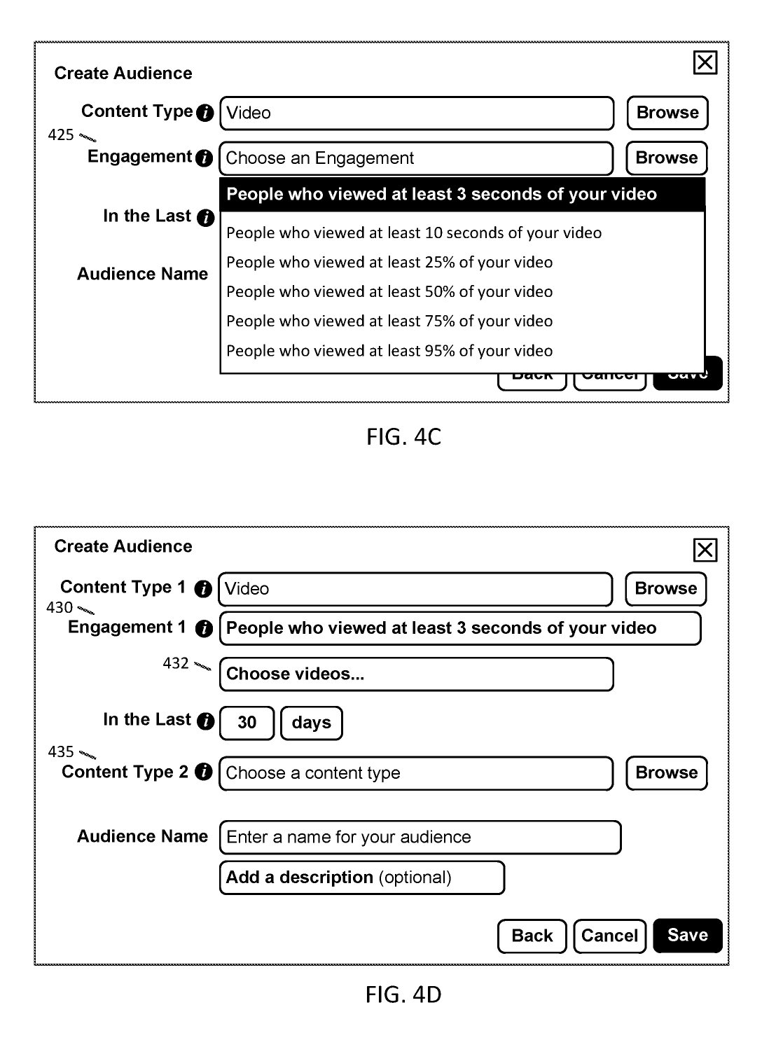

The audience creation module 235 receives the request from a content provider to create a new custom audience for a content item, such as a sponsored content item in the form of an advertisement. FIG. 4A illustrates an example user interface with which a content provider interacts to begin the process of targeting a content item to an audience of defined users as a custom audience for the content provider. Among the options presented to the content provider is the source of the data used to generate the custom audience. For example, in FIG. 4A, the content provider may elect to generate the custom audience based on a customer list, website traffic, application activity, or engagement.

Responsive to the content provider selecting the engagement option 400 in FIG. 4A, the audience creation module 235 provides a user interface that allows the content provider to input information about the desired custom audience. As shown in FIG. 4B, this information may include engagement information comprising one or more content types 405, one or more engagement types 410, duration 415, and a name 420 for the new custom audience. As used throughout the description, the term “engagement type” means a type of user engagement with content items on the online system 140 or on a third-party system 130. The engagement type may vary depending on the content type such that the content provider is presented with the option of selecting a content type before selecting a corresponding engagement type. For example, FIGS. 4B-4D illustrate a video content type where the selectable engagement types include watching the video content item for a specified period of time or to a specified percentage of completion. In other embodiments, the content type is a page of a content provider and a corresponding engagement type may include the length of time the user views the content item. In still other embodiments, the content type is a group or event of a content provider and a corresponding engagement type may include user interactions with the content item, such as joining the group or indicating a desire to attend the event. Additional engagement types include interactions with a carousel of content items and other interactions as discussed herein.

Engagement types may be categorized on the basis of time (e.g., users who watched the first three seconds of a video, users who watched any ten seconds of a video) or percentage of completion (e.g., users who watched at least 75% of a video). Other categories of engagement types include users of the online system 140 who interacted with an online system page associated with the content provider (e.g., by liking the page, sharing the page, liking or commenting on a post on the page, messaging the page, etc.) or users of the online system who clicked through online system content to a page associated with the content provider (e.g., a product catalog). The user may select various types of engagement according a content type of interest to the content provider, such as interaction with content items in a carousel or other types.

The audience creation module 235 displays the engagement types to the content provider through the client device 110 and receives input through the client device 110 regarding which engagement type(s) the content provider would like to use to create a new custom audience. For example, a content provider interested in engagement data related to a previously uploaded video content item may request engagement interaction data of users that viewed at least three seconds of the video content item to determine a target audience for a related sponsored content item. As shown in FIG. 4C, the user interface may comprise a drop-down menu 425 through which the content provider may select at least one engagement type describing user interaction with a content item. FIG. 4D illustrates that the content providers may also use a content item selection interface 432 to select specific content items for the engagement types. For example, a content provider may select one or more individual content items, or select all content items of the selected content type associated with the content provider.

In some embodiments, a content provider can define custom audiences that have a combination of engagement interactions by specifying multiple content and engagement types 430 and 435 to be used in generating the custom audience, as shown in FIG. 4D. For example, in FIG. 4D, the user has indicated that Content Type 1 is a video with an engagement type of users who have watched at least three seconds of the video. The user is also presented with the option of designating a second content type 435 for which the user may then specify an engagement type and specific content item(s) interacted with by the user in the way specified by the engagement type.

The engagement types may relate to a single content item (e.g., users who watched 75% of a video and users who liked the video) or different content items (e.g., users who watched the first three seconds of two different videos) and may be used by the content provider to include or exclude users from the custom audience. For instance, in the previous examples, the content provider may wish to include in the custom audience users who watched 75% of a video (who may not have liked the video) as well as users who liked the video (who may not have watched 75% of the video). Or a content provider may wish to include in the custom audience users who watched the first three seconds of a first video and exclude users who watched the first three seconds of a second video).

The audience creation module 235 also allows the content provider to specify the look-back window for purposes of retrieving user engagement data. For example, the content provider can specify that it would like to create a custom audience based on user engagement data generated within the last 24 hours or the last 30 days, as shown in FIG. 4D. In some embodiments, the content provider can choose not to specify a look-back window, and the audience creation module 235 gathers all available engagement data for the selected engagement types.

Responsive to the content provider selecting at least one engagement type for one or more content items on the online system 140, the audience creation module 235 queries the action log 225 for the data corresponding to the at least one engagement type. The action log 225 sends the requested engagement data to the audience creation module 235, which uses the engagement data to create a new custom audience comprising online system users who satisfied the selected engagement type(s). In some embodiments, the audience creation module 235 re-runs the query after a specified period of time to identify new or different audience members as the users performing the specified interaction within the specified time changes.

In some embodiments, the content provider inputs through the client device 110 additional parameters for the custom audience. For example, the content provider might specify that users targeted for receiving the content item(s) associated with the new custom audience should have a gender listed as male and should have an interest in sports, as determined by the online system 140. In other embodiments, the content provider may use the custom audience to exclude users of the online system 140 from subsequent targeting. For example, a content provider running a video campaign for a new television show may use engagement data from the first video to determine which users to exclude from the custom audience for the second video on the assumption that the users who interacted with the first video have already decided whether to watch the new television show and thus need not be retargeted. The content provider can therefore conserve resources by focusing subsequent advertising efforts on users that have not yet engaged with the content.

Responsive to receiving the user input, the audience creation module 235 queries the user profile store 205 for a list of users who have the specified characteristics, as determined by the online system 140. The user profile store 205 returns the requested list to the audience creation module 235, which uses the list to add and/or remove users from the custom audience based on the specified characteristics. The audience may also be shown to the content provider, for example to indicate the number of users in a custom audience. In some embodiments, the specific users in the audience are not displayed and instead characteristics of the audience are displayed, such as the number of users or various characteristics (e.g., demographic information) for the content provider to better understand information about the audience without providing individually-identifiable information to the content provider. The audience creation module 235 then sends the custom audience to the audience store 245 for storage and displays the custom audience on the client device 110.

After generating the custom audience, the audience creation module 235 receives a content item to associate with the custom audience from the content provider, who may also specify other parameters for presenting the content item. For example, the additional content item may be sponsored by the content provider and compete with other sponsored content for display to users. When a user requests content from the online system 140 and is a member of the audience, the online system 140 (e.g., via the user interface server 210) may select the provided content item for presentation to the user when the other parameters are met.

### Exemplary Method

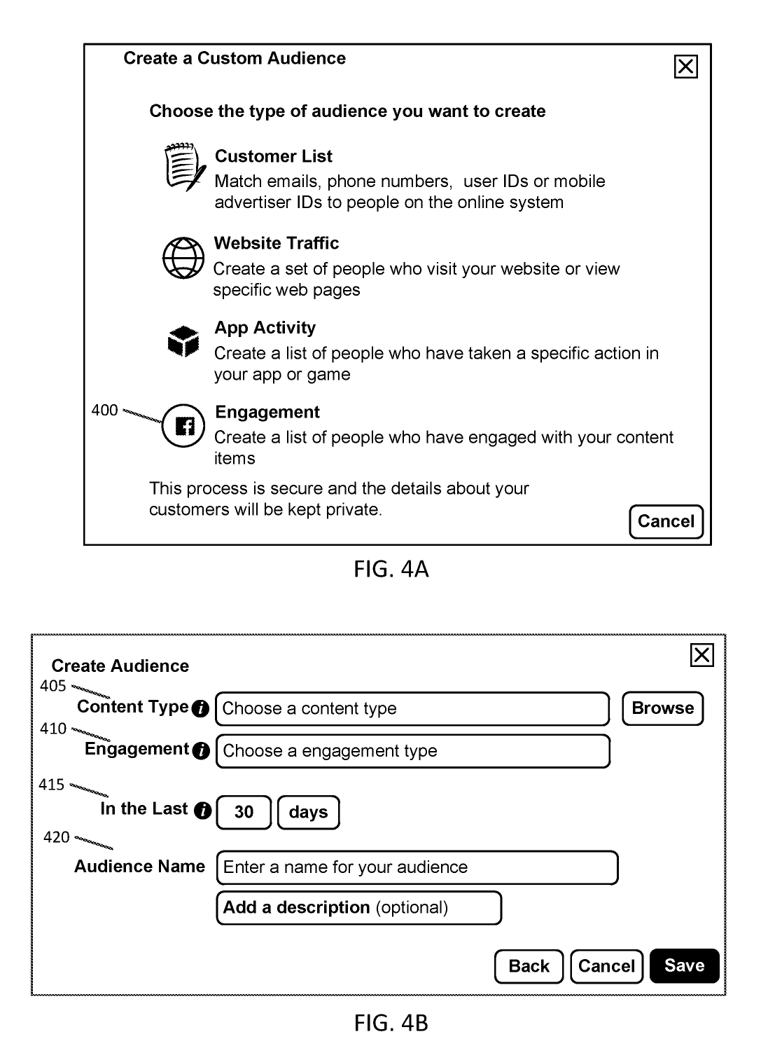

FIG. 3 is an interaction diagram illustrating an example method for using engagement targeting to generate a custom audience for a new content item or content campaign, according to one embodiment. As users of an online system 140 interact with content items (not shown) on the online system 140, the action logger 220 logs 305 the user interactions and sends 310 the interactions to the action log 225 for storage. Examples of interactions with content items include watching a content item for a specified period of time or to a specified period of completion or following an online system link associated with a content provider to a third party website associated with the content provider.

When a content provider wishes to generate an audience for a content item, the audience creation module 235 receives input from a content provider through a client device 110 providing 315 the engagement type and engagement interaction that the content provider wishes to use to generate the custom audience. In one embodiment, the content provider selects a single engagement type and engagement interaction for one content item. Alternatively, the content provider may select multiple engagement types and engagement interactions to define a custom audience that has a combination of characteristics. As described above in conjunction with FIG. 2, engagement types include interactions with an online system page associated with the content provider or interactions with (and time spend viewing) content items on a page associated with the content provider (e.g., a product catalog). Additional engagement types for content items in the form of videos include the time and/or percentage of the video that the user watched. In some embodiments, the content provider specifies a look-back window such that the audience creation module 235 only retrieves engagement data generated during the specified window. For example, the content provider can specify that it would like to use engagement data generated within the last 48 hours or the last 30 days. Alternatively, the content provider can choose not to specify a content window, and the audience creation module 235 will gather all engagement data for the selected engagement types.

The audience creation module 235 queries 320 the action log 225 for engagement data responsive to the content provider selecting the engagement types and engagement interactions, and the action log 225 sends 325 the retrieved engagement data to the audience creation module 235. Responsive to receiving the engagement data, the audience creation module 235 generates 330 a custom audience comprising online system users who satisfied the selected engagement types and engagement interactions.

In some embodiments, the audience creation module 235 receives 335 user input comprising additional audience parameters. For example, the content provider might specify that the custom audience should contain a subset of the users included in the engagement data who meet certain user characteristics. Characteristics may include demographic information about users of the online system 140, such as age, gender, political views, education status, college year, relationship status, gender(s) interested in dating, and geographic region information. Additionally or alternatively, the content provider might specify that the custom audience should expire after a certain date or might input parameters to exclude users of the online system 140 who have already engaged with the content item, as discussed above in conjunction with FIG. 2.

At 340, the audience creation module 235 queries the user profile store 205 for a list of online system users who satisfy the additional parameters. The user profile store 205 sends 345 the requested list of users to the audience creation module 235, which uses the list to edit 350 the custom audience based on user input. In one embodiment, the audience creation module 235 adds users who satisfy the additional parameters to the custom audience. In another embodiment, the audience creation module 235 removes users who satisfy the additional parameters from the custom audience. In still other embodiments, the audience creation module 235 adds users who satisfy certain parameters and removes users who satisfy other parameters. At 355, the audience creation module 235 sends the custom audience to the audience store 245 for storage and provides 360 the custom audience for display on the client device 110.

After generating the custom audience, the audience creation module 235 receives from the content provider one or more content items with which to associate the custom audience. The content provider may also specify other parameters for presenting the content item. When an online system user who is a member of the custom audience requests content on the online system 140, the online system 140 (via the user interface server 210) may select the provided content item for presentation to the user when the other parameters are met.

### Additional Considerations

The foregoing description of the embodiments have been presented for the purpose of illustration; it is not intended to be exhaustive or to limit the embodiments to the precise forms disclosed. Persons skilled in the relevant art can appreciate that many modifications and variations are possible in light of the above disclosure.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may be comprise a general-purpose computing device selectively activated or reconfigured by a computer program stored on a computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

1. A method comprising:
providing, by an online system, one or more content items to a plurality of users, the content items associated with a content provider;
automatically monitoring, by the online system, user engagement by the plurality of users with the one or more content items on the online system associated with the content provider;
storing the user engagement in an action log;
receiving, from a client device associated with a content provider, a request to generate a custom audience of users for the content provider to target with a new content item;
receiving, from the client device, user selection of an engagement type and user input of audience parameters;
querying the action log for users having engagement data matching the engagement type and the audience parameters;
generating the custom audience using users having user engagement data matching the user engagement data and the audience parameters;
providing the custom audience for display on the client device;
receiving a designated content item for presentation to the custom audience;
receiving a request for content from another client device associated with a user in the custom audience; and
providing the designated content item to the other client device for presentation to the user.

2. The method of claim 1, wherein the engagement type comprises interactions between users of the online system and interface elements of the one or more content items.

3. The method of claim 2, wherein the interactions comprise watching a content item for a specified period of time or to a specified percentage of completion.

4. The method of claim 2, wherein the interface element is an online system link associated with the content provider to a third party website associated with the content provider.

5. The method of claim 1, wherein the automatically monitoring comprises logging user engagement with content items on the online system without a specific request from the content provider.

6. The method of claim 1, wherein the user input comprises an instruction to store the custom audience for a specified period of time.

7. The method of claim 1, wherein the user input comprises an instruction to include user interactions that occurred within a specified period of time.

8. A non-transitory computer readable storage medium storing instructions that, when executed by a computing system, cause the computing system to perform operations comprising:
providing, by an online system, one or more content items to a plurality of users, the content items associated with a content provider;
automatically monitoring, by the online system, user engagement by the plurality of users with one or more content items on the online system associated with the content provider;
storing user engagement data in an action log;
receiving, from a client device associated with a content provider, a request to generate a custom audience of users for the content provider to target with a new content item;
receiving, from the client device, user selection of an engagement type and user input of audience parameters;
querying the action log for user engagement data matching the engagement type and the audience parameters;
generating the custom audience using users having engagement data matching the user engagement data and the audience parameters;
providing the custom audience for display on the client device;
receiving a designated content item for presentation to the custom audience;
receiving a request for content from another client device associated with a user in the custom audience; and
providing the designated content item to the other client device for presentation to the user.

9. The non-transitory computer readable storage medium of claim 8, wherein the engagement type comprises interactions between users of the online system and interface elements of the one or more content items.

10. The non-transitory computer readable storage medium of claim 9, wherein the interactions comprise watching a content item for a specified period of time or to a specified percentage of completion.

11. The non-transitory computer readable storage medium of claim 9, wherein the interface element is an online system link associated with the content provider to a third party website associated with the content provider.

12. The non-transitory computer readable storage medium of claim 8, wherein the automatically monitoring comprises logging user engagement with content items on the online system without a specific request from the content provider.

13. The non-transitory computer readable storage medium of claim 8, wherein the user input comprises an instruction to store the custom audience for a specified period of time.

14. The non-transitory computer readable storage medium of claim 8, wherein the user input comprises an instruction to include user interactions that occurred within a specified period of time.

15. A system comprising:
a processor for executing instructions;
a computer-readable medium having instructions executable by the processor instructing the processor to:
provide, by an online system, one or more content items to a plurality of users, the content items associated with a content provider;
automatically monitor, by the online system, user engagement by the plurality of users with the one or more content items on the online system associated with the content provider;
store the user engagement in an action log;
receive, from a client device associated with a content provider, a request to generate a custom audience of users for the content provider to target with a new content item;
receive, from the client device, user selection of an engagement type and user input of audience parameters;
query the action log for user engagement data matching the engagement type and the audience parameters;
generate the custom audience using users having engagement data matching the user engagement data and the audience parameters;
provide the custom audience for display on the client device;
receive a designated content item for presentation to the custom audience
receive a request for content from another client device associated with a user in the custom audience; and
provide the designated content item to the other client device for presentation to the user

16. The system of claim 15, wherein the at least one engagement type comprises interactions between users of the online system and interface elements of the one or more content items.

17. The system of claim 16, wherein the interactions comprise watching a content item for a specified period of time or to a specified percentage of completion.

18. The system of claim 16, wherein the interface element is an online system link associated with the content provider to a third party website associated with the content provider.

19. The system of claim 15, wherein the user input comprises an instruction to store the custom audience for a specified period of time.

20. The system of claim 15, wherein the user input comprises an instruction to include user interactions that occurred within a specified period of time.
